(19) United States
(12) Patent Application Publication
(10) Pub. No.: US 2011/0107974 A1
(43) Pub. Date: May 12, 2011

(54) SYSTEM AND METHOD OF INSULATING A STOCK TANK

(76) Inventors: Thomas K. Reusche, Elburn, IL (US); Philip E. Chumbley, Aurora, IL (US)

(21) Appl. No.: 12/906,699

(22) Filed: Oct. 18, 2010

Related U.S. Application Data
(60) Provisional application No. 61/258,942, filed on Nov. 6, 2009.

(51) Int. Cl. A01K 7/00

(52) U.S. Cl. 119/73

(57) ABSTRACT

A system for insulating a conventional stock tank configured to retain drinking water for an animal. The system includes at least one insulating member configured to secure to the conventional stock tank. The at least one insulating member is configured to trap air between the at least one insulating member and one or both of a retaining wall of the conventional stock tank or a surface within a water-retaining cavity of the conventional stock tank.

### RELATED APPLICATIONS

The present application claims priority to U.S. Provisional Application No. 61/258,942, entitled “Stock Tank Insulator,” filed Nov. 6, 2009, which is hereby incorporated by reference in its entirety.

### FIELD OF THE INVENTION

Embodiments of the present invention generally relate to a stock tank, and, more particularly, to a system and method of insulating a stock tank.

### BACKGROUND OF THE INVENTION

Stock tanks are commonly used in livestock operations to provide drinking water to animals. Generally, stock tanks are located outdoors within a pen where animals are kept. As such, the stock tanks may be exposed to temperature extremes as well as wind, rain, and snow.

Typically, care is taken to ensure that water within a stock tank does not freeze during winter months, as livestock are unable to drink frozen water. To this end, an electric stock tank de-icer may be used to supply heat to the water within the stock tank.

Many modern stock tank de-icers are thermostatically-controlled to activate when the water temperature approaches freezing and deactivate when the water is heated to a predetermined temperature. The de-icers are typically rated at 1000 watts or more in order to provide enough heat to the tank.

In order for a de-icer to heat the water and then deactivate, heat loss from the stock tank must be less than the heat input from the de-icer. If the heat loss is greater than the heat input, the water will continue to lose heat and will eventually freeze even if the de-icer is running all the time. Because a 1000 watt heater can be expensive to operate continuously, it is desirable to reduce its duty cycle by reducing the heat loss from the water by insulating the tank.

Farmers and ranchers often position a stock tank against a wall of an outbuilding or partially surround the tank with straw bales in order to block the wind. While this is effective in reducing the accelerated heat loss due to wind chill, it does not ameliorate the normal heat loss via convection and radiation.

U.S. Pat. No. 4,100,885 (“Kapplinger”) discloses a specialized stock tank having insulated structural components that are configured to prevent heat loss during the winter. Kapplinger includes a well that extends down into the water as an integral part of the unit. The well is configured to minimize the amount of water that is exposed to the cold air. However, while the specialized stock tank of Kapplinger significantly reduces heat loss, as a specialized tank, it is inapplicable to numerous existing conventional stock tanks.

U.S. Pat. No. 5,921,230 (“Vessells”) discloses an insulating blanket for a hot water heater where the blanket contains piping for circulating of hot waste gases. The blanket disclosed in Vessels forms a part of the heating system itself, and is not a passive insulating device.

U.S. Pat. No. 4,808,356 (“West”) discloses a jacket around a water heater where expanding foam may be used to fill the intervening space. However, the expanding foam jacket is susceptible to saturation and degradation when exposed to water, thereby adversely affecting the insulating properties.

Other enclosures have been proposed for jacketing hot water heaters. The jacketed hot water heaters are configured to contain water in the event of a leak in the water tank. These jacketed water heaters do not, however, provide thermal insulation in an outdoor environment while providing access to the water.

With respect to swimming pools, for example, in order to reduce heat loss from the water surface, floating insulation is often used. Foam or bubble wrap is often floated on the surface of the water to provide a layer of trapped air thereby significantly reducing heat loss. However, while the water level in a swimming pool stays constant, the water level in a stock tank is continually changing.

FIG. 1 illustrates a cross-sectional view of a conventional stock tank 10. FIG. 2 illustrates a cross-sectional view of a conventional stock tank 10′. As shown in FIGS. 1 and 2, the stock tanks 10 and 10′ are defined by a base 12 and 12′, respectively, integrally connected to retaining walls 14 and 14′, respectively. Upper ends of the retaining walls 14 and 14′ terminate in rounded lips 16 and 16′, respectively.

The walls 14 of the stock tank 10 taper downward from the lip 16 to the base 12. The walls 14′ of the stock tank 10′ step down from the lip 16′ to the base 12′.

A water-retaining cavity 18 is defined between the walls 14 and the base 12. Similarly, a water-retaining cavity 18′ is defined between the walls 14′ and the base 12′. The water-retaining cavities 18 and 18′ are configured to retain water for animals to drink.

Because the retaining walls 14 and 14′ slope and step inwardly from the lips 16 and 16′, respectively, to the base 12 and 12′, respectively, as animals drink water within the cavities 18 and 18′, the water level drops in the tank and the exposed surface area of the water surface decreases. Accordingly, if a slab of rigid foam on the surface of the water were to be used to insulate the stock tanks 10 and 10′, as an animal drank and the water level decreased, the slab would wedge in the tank and an air gap would open between the foam slab and the water, thereby adversely affecting the effectiveness of the insulation. Conversely, if the foam slab was sized to fit the bottom of the tank, there would be exposed gaps around its edge when the tank is full, thereby exposing around 20% of the water surface to the cold air.

Overall, exposure to rain and snow limits the materials that are used to insulate a stock tank. Additionally, care should be taken to ensure that animals are discouraged from chewing the insulating materials. Additionally, the insulating material should prevent free movement of air between the insulating material and the walls of the stock tank in order to preclude heat loss by convection. The systems and methods explained above, however, do not adequately address all of these considerations.

### SUMMARY OF THE INVENTION

Certain embodiments of the present invention provide a system for insulating a conventional stock tank configured to retain drinking water for an animal. The system includes at least one insulating member configured to secure to the conventional stock tank. The at least one insulating member is configured to trap air between the at least one insulating member and one or both of a retaining wall of the conventional stock tank or a surface within a water-retaining cavity of the conventional stock tank.

The at least one insulating member may include an insulating jacket configured to wrap around the conventional stock tank.

The insulating jacket may include a flexible lining, and a foam blanket attached to, or enclosed within, the flexible lining. The foam blanket may be formed of a water-resistant, closed-cell material. Alternatively, the foam blanket may be formed of open-cell foam. The flexible lining may be formed of an elastomeric material. At least one draw string may be secured to the flexible lining.

The insulating jacket may include a plurality of vertical air pockets. The insulating jacket may include a plurality of spacer tubes, wherein the spacer tubes are configured to be sandwiched between the insulating jacket and the retaining wall of the conventional stock tank.

The at least one insulating member may include a cover suspended above an opening of the conventional stock tank by a rigid frame. The cover may include at least one flap over at least one opening. The flap is configured to be engaged by an animal. For example, the animal may nudge the flap open and position its head through the opening to gain access to the water within the stock tank. The at least one flap may be spring-biased, connected to the cover through at least one hinge, or the like.

The at least one insulating member may include a plurality of flexible vertical straps connected to a covering wall. The plurality of flexible vertical straps are configured to be positioned about an opening of the conventional stock tank.

The insulating member may include a drinking chute configured to be secured to the conventional stock tank, and a flexible cover that stretches from an upper portion of the conventional stock tank to upper portions of the drinking chute. A float may be positioned within the drinking chute.

The at least one insulating member may include a floating cover including a plurality of floating, interlocking insulating blocks.

Certain embodiments of the present invention provide a system for insulating a conventional stock tank configured to retain drinking water for an animal. The system includes an insulating jacket configured to securely wrap around a retaining wall of the conventional stock tank. The insulating jacket is configured to trap air between the insulating jacket and the retaining wall. The system also includes a flexible cover suspended above the conventional stock tank by a rigid frame. The flexible cover is configured to trap air between the flexible cover and a surface (such as a water surface or base of the conventional stock tank) within a water-retaining cavity of the conventional stock tank.

The insulating jacket and the flexible cover may be integrally formed as a single unit.

The system may also include a floating cover including a plurality of floating, interlocking insulating blocks. The floating cover is configured to float on water within the water-retaining cavity of the conventional stock tank.

### BRIEF DESCRIPTION OF SEVERAL VIEWS OF THE DRAWINGS

FIG. 1 illustrates a cross-sectional view of a conventional stock tank.

FIG. 2 illustrates a cross-sectional view of a conventional stock tank.

FIG. 3 illustrates an isometric front view of a portion of an insulating jacket, according to an embodiment of the present invention.

FIG. 4 illustrates a cross-sectional view of a top of an insulating jacket secured to a top of a stock tank, according to an embodiment of the present invention.

FIG. 5 illustrates an insulating jacket secured around a stock tank, according to an embodiment of the present invention.

FIG. 6 illustrates a cross-sectional view of an insulating jacket, according to an embodiment of the present invention.

FIG. 7 illustrates an isometric cutaway view of an insulating jacket secured around a stock tank, according to an embodiment of the present invention.

FIG. 8 illustrates an isometric view of an insulating jacket secured around a stock tank, according to an embodiment of the present invention.

FIG. 9 illustrates an isometric view of a rigid frame secured over a stock tank, according to an embodiment of the present invention.

FIG. 10 illustrates an isometric view of covered stock tank, according to an embodiment of the present invention.

FIG. 11 illustrates a cross-sectional view of a covered stock tank, according to an embodiment of the present invention.

FIG. 12 illustrates a cross-sectional view of a covered stock tank, according to an embodiment of the present invention.

FIG. 13 illustrates an isometric view of a covered stock tank, according to an embodiment of the present invention.

FIG. 14 illustrates a cross-sectional view of a covered stock tank, according to an embodiment of the present invention.

FIG. 15 illustrates a cross-sectional view of a float within a covered stock tank, according to an embodiment of the present invention.

FIG. 16 illustrates a cross-sectional view of a floating cover within a stock tank, according to an embodiment of the present invention.

FIG. 17 illustrates an isometric top view of floating insulating blocks, according to an embodiment of the present invention.

The foregoing summary, as well as the following detailed description of certain embodiments of the present invention, will be better understood when read in conjunction with the appended drawings. For the purpose of illustrating the invention, there are shown in the drawings, certain embodiments. It should be understood, however, that the present invention is not limited to the arrangements and instrumentalities shown in the attached drawings.

### DETAILED DESCRIPTION OF THE INVENTION

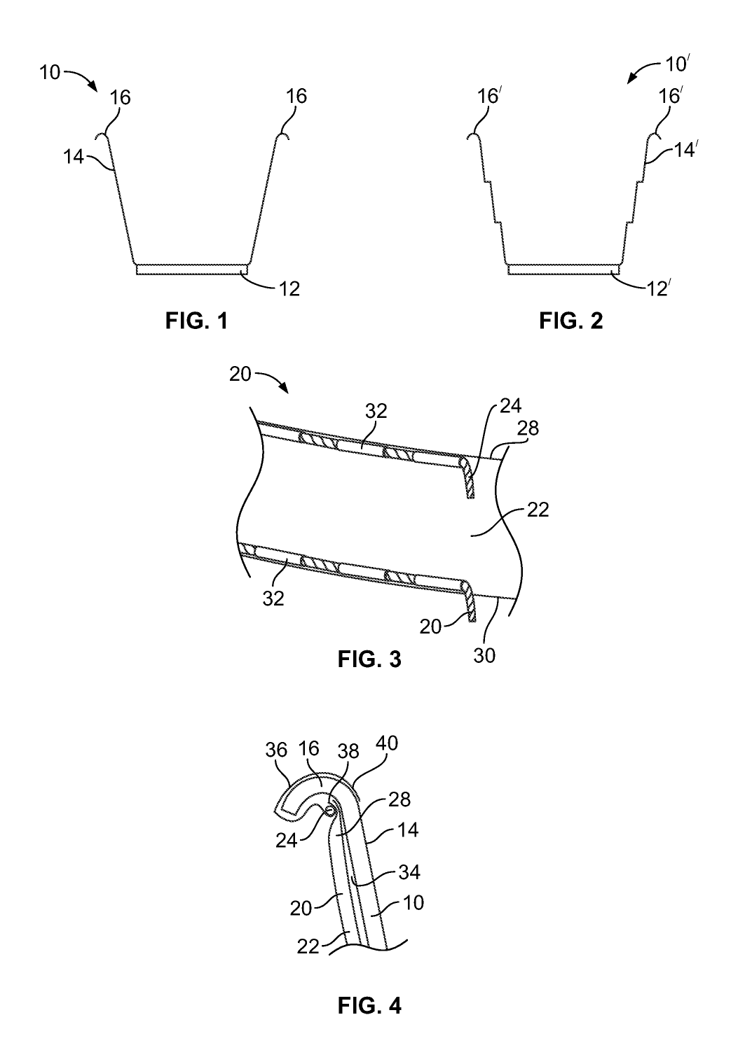

As noted above, FIGS. 1 and 2 illustrate conventional stock tanks 10 and 10′. Embodiments of the present invention provide systems and methods of insulating the stock tanks 10 and 10′. That is, embodiments of the present invention provide systems and methods of retrofitting conventional stock tanks so that they are insulated.

Heat transfer through the walls of a stock tank, such as the stock tanks 10 and 10′, is given by:

Q=−kA(ΔT/Δx)

where Q is the rate in watts at which heat is transferred, k is the coefficient of thermal conductivity for the wall material, A is the wall area through which the heat passes, ΔT is the difference in temperature on opposite sides of the tank wall, and Δx is the thickness of the tank wall.

For a given area A, the heat flow Q for a certain temperature difference ΔT can be reduced by either choosing a material with a small thermal coefficient k or by increasing the thickness Δx of the material. For water, the coefficient k is 0.6 watts/meter-degree Kelvin (w/m·K), but for glass-filled polymer, of which most plastic stock tanks are formed, the coefficient is also around 0.6 w/m·K. For a stock tank made of galvanized steel, the value for k can be as high as 50. Thus, the walls of the stock tank provide little to no insulation for the water in either case.

On the other hand, air has a thermal coefficient of 0.025 w/m·K and provides good insulation. A layer of trapped air (around ten times thicker than the walls of the stock tank) between the stock tank and the outside environment would decrease the heat flow through the tank walls by a factor of around 240. Accordingly, a stock tank losing heat through its walls at a rate of 400 watts would instead lose heat at a rate of less than 2 watts. Thus, for a tank having walls that are 0.25 inches thick, surrounding the tank with air insulation 2.5 inches thick could reduce the heating required to keep the water ice-free by around 280 kilowatt-hours per month. Therefore, an enclosure that traps air around the stock tank would form an effective way of insulating the tank.

FIG. 3 illustrates an isometric front view of a portion of an insulating jacket 20, according to an embodiment of the present invention. The jacket 20 may be a contiguous ring, or it may be a strap having free ends that are configured to secure to one another, such as through ties, zippers, or the like. The jacket 20 is configured to wrap around retaining walls of a stock tank.

The jacket 20 includes a foam blanket (hidden from view) that is attached to, or enclosed within, a flexible, durable lining 22. The foam blanket is a water-resistant, closed cell construction. Optionally, the foam blanket may be formed of open-cell foam, as long as the lining 22 is water-tight and completely encloses the foam blanket. Accordingly, the lining 22 may be formed of an elastomeric material, such as rubber, or the like.

As shown in FIG. 3, upper and lower draw strings 24 and 26 are secured around upper and lower edges 28 and 30, respectively, of the insulating jacket 20, through open-ended loops or sleeves 32. That is, the draw strings 24 and 26 pass through central passages of the sleeves 32. The draw strings 24 and 26 are configured to tighten the upper and lower edges 28 and 30, respectively, to the retaining walls of the stock tank. As such, the tightened draw strings 24 and 26 prevent rain and air from entering the volume of space between the jacket 20 and the retaining walls of the stock tank.

The jacket 20 is configured to wrap completely around a large stock tank, such as a 150 gallon tank, while also being able to wrap around smaller tanks. When wrapped around a smaller tank, portions of the jacket 20 may overlap other portions of the jacket 20.

FIG. 4 illustrates a cross-sectional view of the upper edge 28 of the insulating jacket 20 secured to a top of the stock tank 10, according to an embodiment of the present invention. While the stock tank 10 is shown, the stock tank 10′ may also be used.

As shown in FIG. 4, the top edge 28 of the jacket 20 is securely cinched around the stock tank 10 through the tightened draw-string 24, which draws and captures the lining 22 into the retaining wall 14. A gap 34 is defined between the inner surface of the jacket 20 and the outer surface of the retaining wall 14.

A clip 36 may be used to securely fasten the upper edge 28 of the jacket 20 to the lip 16 of the stock tank 10. For example, a first end 38 of the clip 36 may latch around the draw string 24, while the opposite end 40 of the clip 36 wraps around an inner surface of the lip 16, thereby securely clipping the upper edge 28 of the jacket 20 to the lip 16. The clip 36 may be formed of metal or plastic, for example. A plurality of clips 36 may be used to secure the jacket 20 to the stock tank 10, thereby ensuring that the upper edge 28 of the jacket 20 does not slide down the retaining walls 14.

The jacket 20 and the air gap 34 between the jacket 20 and the retaining wall 14 provide water and air-tight insulation for the stock tank 10.

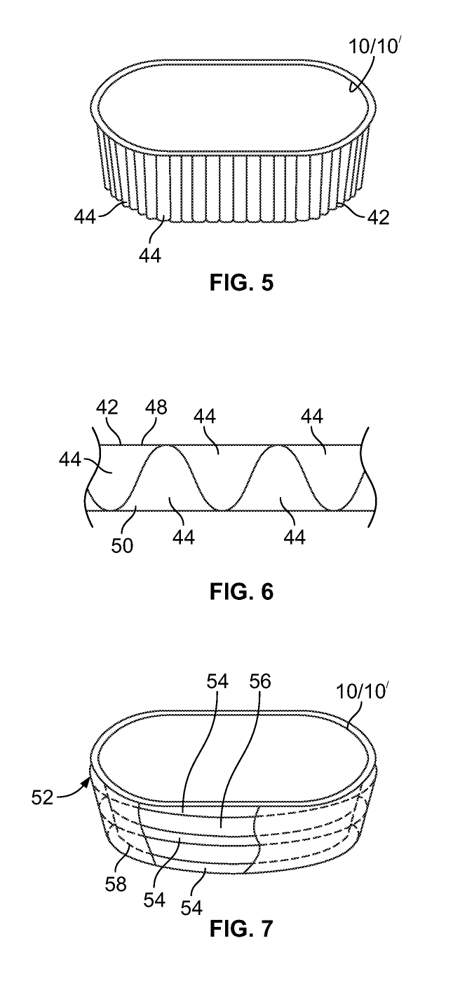

FIG. 5 illustrates an insulating jacket 42 secured around a stock tank 10 or 10′, according to an embodiment of the present invention. The insulating jacket 42 includes a plurality of vertical air pockets 44. The jacket 42 may include an air inlet valve (not shown) that allows air to be filled into each of the air pockets 44, such as through an air compressor or pump. The jacket 42 may be formed of a flexible plastic or rubber, such that the air pockets 44 retain air.

FIG. 6 illustrates a cross-sectional view of the insulating jacket 42. The jacket 42 includes inner and outer support walls 48 and 50, respectively, that secure the air pockets 44 within the jacket 42. The support walls 48 and 50 may be integrally formed with the air pockets 44. Optionally, the jacket 42 may include only one of the support walls 48 and 50 with the air pockets 44 connected thereto.

As shown in FIG. 6, the air pockets 44 may overlap one another to compensate for areas where the walls of the individual pockets 44 may be stitched or welded together.

As shown in FIGS. 5 and 6, the jacket 42 provides a double-walled, air-tight envelope that wraps around the retaining walls of the stock tank 10 or 10′. The jacket 42 may be wrapped around the stock 10 or 10′, and then inflated akin to an air mattress.

Once the jacket 42 is inflated, the air trapped within the air pockets 44 provides an insulating layer around the stock tank 10 or 10′ The vertical orientation of the air pockets 44 allows the jacket 42 to be easily wrapped around the stock tank 10 or 10′ without creasing the jacket 42. Optionally, the air pockets 44 may be horizontally oriented.

Also, the draw strings shown and described with respect to FIGS. 3 and 4 may be used with the jacket 42.

The relationship between air pressure and volume within the inflated jacket 42 at various temperatures is given by:

p₁V₁/T₁=p₂V₂/T₂

where p is pressure, V is volume, and T is temperature. For a given pressure of 1 atmosphere for p₁ and p₂, a decrease in temperature will cause a decrease in the volume that the air occupies. If the jacket is filled to a pressure of 1 atm when the air temperature is 300 K (80° F.), the volume V₂ occupied by the air when the temperature drops to 233 K (−40° F.) will be 0.78V₁, or 22% less, and the jacket 42 will sag. To compensate, the jacket 42 may be filled to a pressure of at least 1.29 atm so that, when the temperature drops, the air inside the jacket 42 will be greater than 1 atmosphere and the jacket 42 will not sag. To that end, the jacket 42 may be inflated when the temperature is low. As the outside temperature increases towards the approach of spring, the pressure inside the pockets 44 of the jacket 42 will increase but the construction allows it to easily withstand 1.5 atmospheres.

FIG. 7 illustrates an isometric cutaway view of an insulating jacket 52 secured around a stock tank 10 or 10′, according to an embodiment of the present invention. The jacket 52 includes horizontal, flexible tubes 54 that are secured between inner and outer flexible walls 56 and 58, respectively. Optionally, the jacket 52 may not include the inner wall 56.

The tubes 54 space the air-tight wall 58, or cover, from the stock tank 10 or 10′. The tubes 54 and the cover 58 form an air pocket between the cover 58 and the retaining walls of the stock tank 10 or 10′. The tubes 54 may be formed of foam or the like, or can be plastic inflatable tubes.

The tubes 54 may be secured in position with tape or straps that extend downwardly from the walls of the stock tank 10 or 10′. Alternatively, short sections of the tubes 54 may be attached to the walls of the stock tank 10 or 10′ and spaced around the periphery of the stock tank 10 or 10′ to form spacers for the cover 58. Such a configuration may be used when the walls of the stock tank 10′ are stepped, such as in FIG. 2.

The draw strings shown and described with respect to FIGS. 3 and 4 may be used with the jacket 52.

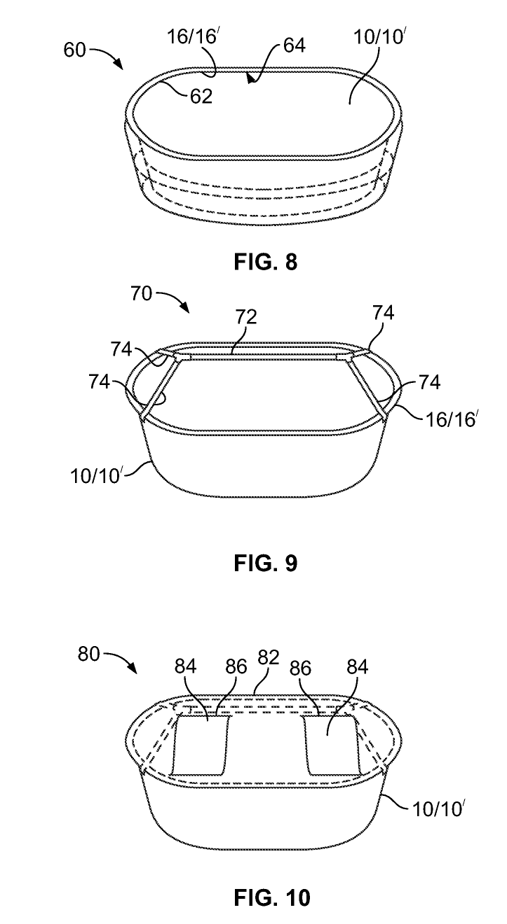

FIG. 8 illustrates an isometric view of an insulating jacket 60 secured around a stock tank 10 or 10′ according to an embodiment of the present invention. The jacket 60 may be similar to any of the jackets described in FIGS. 3-7, except that the top edge 62 extends and wraps over the lip 16 or 16′ of the stock tank 10 or 10′ in order to secure the jacket 60 to the stock tank 10 or 10′. The wrap around nature of the jacket 60 ensures that water and air does not infiltrate the resulting air gap between the jacket 60 and the retaining walls of the stock tank 10 or 10′. A draw string 64 may also be secured to the wrapping portion of the jacket 60 about the top edge 62. In this manner, the draw string 64 may be engaged to securely wrap the top edge 62 of the jacket 60 over the lip of the stock tank 10 or 10′.

The lip of the stock tank 10 or 10′, therefore, acts as a spacer that holds the jacket 60 out and away from the retaining walls. The drawstring 64 is engaged to decrease the size of the opening of the jacket 60 so that its diameter is less than that of the diameter of the opening defined within the lip of the stock tank 10 or 10′.

The jacket 60 may also include a lower drawstring, such as shown in FIG. 3, for example.

FIG. 9 illustrates an isometric view of a rigid frame 70 secured over a stock tank 10 or 10′, according to an embodiment of the present invention. The frame 70 includes a central beam 72 that spans over a center of the stock tank 10 or 10′. Angled support legs 74 attach to ends of the central beam 72 and secure to ends of the stock tank 10 or 10 about the lip 16 or 16′. The legs 74 may clamp to the lip 16 or 16′ using clips similar to those shown in FIG. 4. The legs 74 support the central beam 72 above a plane defined by upper edges of the lip of the stock tank 10 or 10′.

FIG. 10 illustrates an isometric view of covered stock tank 80, according to an embodiment of the present invention. The covered stock tank 80 includes a cover 82 that spans over the rigid frame 70 and wraps underneath an outer portion of the lip of the stock tank 10 or 10′. The cover 82 may be formed of a flexible plastic. The cover 82 may be used with or without the jackets shown and described with respect to FIGS. 3-8. Additionally, the cover 82 may be integrally formed with any of the jackets shown and described with respect to FIGS. 3-8.

The cover 82 may include a draw string (not shown) in order to securely cinch the cover 82 around the lip 16 or 16′.

The cover 82 includes flaps 84 that cover openings (hidden by the flaps 84). The flaps 84 are pivotally connected to the cover 82 at upper edges 86. The flaps 84 may pivotally open about the upper edges 86, which define connection joints with the cover 82.

While the cover 82 is shown having two flaps 84 on one side, the cover 82 may include more or less flaps 84 than those shown. For example, the cover may include one large flap that spans from the area shown by one flap 84 to another flap 84, in order to accommodate animals of varying sizes. For example, a steer with large horns may need a large opening in order to pass its head through an opening. Accordingly, the covered stock tank 80 may include one large opening and flap 84 on each side that spans over most, if not all, of the length of the cover 82.

An animal may poke its head through the openings covered by the flaps 84 in order to drink water within the stock tank 10 or 10′.

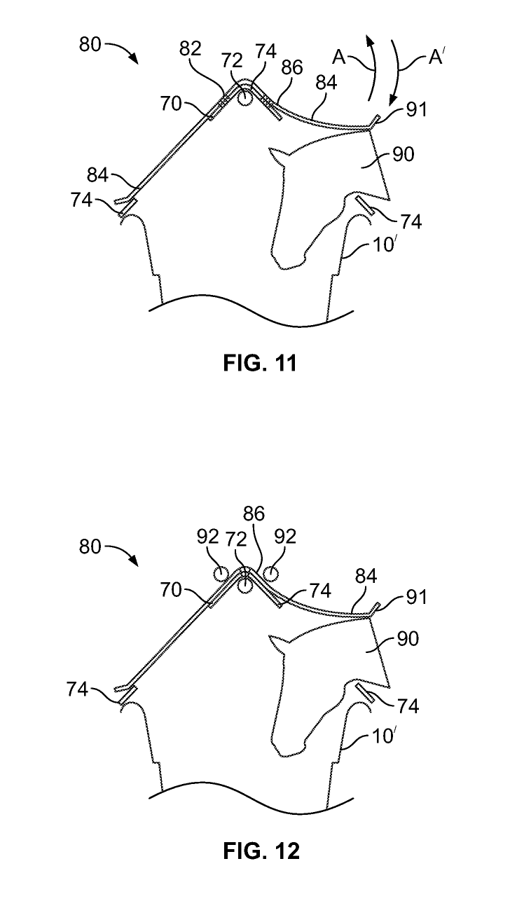

FIG. 11 illustrates a cross-sectional view of the covered stock tank 80. An animal 90 may nudge the flap 84 open in the direction of arc A. For example, the animal may nudge its snout underneath an upturned end 91 of the flap 84 and subsequently pry open the flap 84 in the direction of arc A. The animal then passes its head through the opening underneath the flap 84. When the animal 90 removes its head, the flap 84 pivots back down in the direction of arc A′ to cover the opening.

The flap 84 may be hinged so that it closes through gravity. Optionally, the flap 84 may include a connection joint that is spring-loaded, counterbalanced, or the like.

Also, alternatively, the flap 84 may be connected to an underside of the cover through a spring-biased mechanism. In this manner, the animal would push the flap open into the enclosed area of the covered stock tank 80. When the animal 90 removes its head, the spring-biased mechanism forces the flap 84 back into a closed position.

FIG. 12 illustrates a cross-sectional view of the covered stock tank 80, according to an embodiment of the present invention. As shown, external bars 92 may be used to compressively sandwich the upper edges 86 of the flap 84 between the bars 92 and portions of the rigid frame 70.

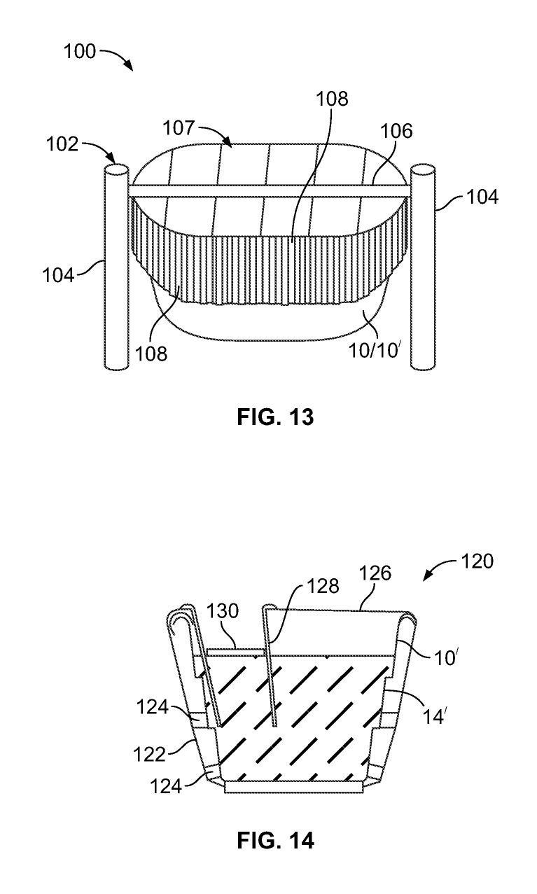

FIG. 13 illustrates an isometric view of a covered stock tank 100, according to an embodiment of the present invention. The covered stock tank 100 includes a stock tank 10 or 10′, which may include any of the jackets shown and described with respect to FIGS. 3-8. A support structure 102 includes opposing columns 104 at opposite ends. A cross beam 106 spans from upper ends of the opposing columns 104. A covering wall 107 extends below the cross beam 106. A plurality of flexible, plastic straps 108 extend from edges of the covering wall 1078 and extend outwardly about the lip of the stock tank 10 or 10′. The vertical straps 108 are connected to the covering wall 107, but their opposite ends are free. Thus, an animal may stick its head through and between the plastic straps 108 in order to gain access to water within the stock tank 10 or 10′.

The covered stock tank 100 allows animals of varying shapes and sizes to gain access to water within the stock tank 10 or 10′. Because animals may poke their heads through the straps 108 at various points around the stock tank 10 or 10′, there is no need for strategically placed openings covered by flaps.

FIG. 14 illustrates a cross-sectional view of a covered stock tank 120, according to an embodiment of the present invention. The covered stock tank 120 includes a stock tank 10′, although a stock tank 10 may be used.

A jacket 122 is secured around the stock tank 10′, as discussed above. Spacers 124 may be used to space the jacket 122 from the retaining wall 14′ of the stock tank 10′. The jacket 122 may be integrally connected to a cover 126 that extends and stretches over the lip 16 and onto an upper edge of a drinking chute 128. The cover 126 traps air between the inner surface of the retaining wall 14′ and the drinking chute 128.

A float 130 is positioned within the drinking chute 128. The float 130 may be formed of plastic, foam, wood, or the like. As the water level drops, the float 130 recedes within the drinking chute 128. As such, the float 130 covers the water within the drinking chute 128. However, an animal may push the float downward to gain access to the water.

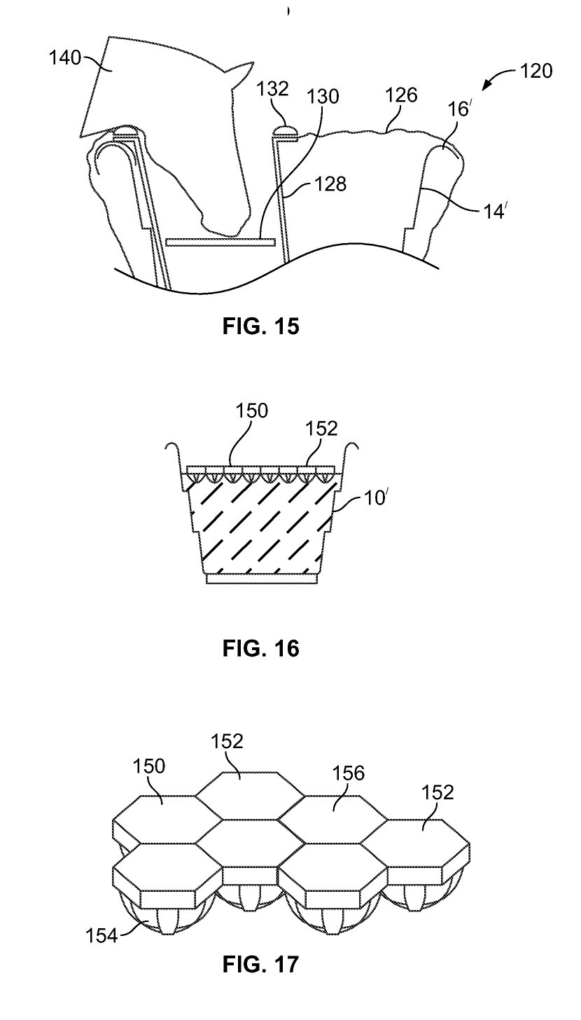

FIG. 15 illustrates a cross-sectional view of the float 130 within the covered stock tank 120. As shown in FIG. 15, in particular, a clamping collar 132 securely and sealingly clamps edges of the cover 126 to upper edges of the drinking chute 128. As the animal 140 places its head into the drinking chute 128 and engages the float 130, the float 130 moves below the surface of the water, thereby allowing the animal 140 to drink the water. When the animal 140 removes its head from the drinking chute 128, the buoyancy of the float 130 ensures that it floats on the surface of the water, thereby covering the water within the chute 128 from the elements. The trapped air between the jacket 122 and the retaining walls 14′, as well as the trapped air between the cover 126 and the surface of the water insulates the stock tank 10′.

FIG. 16 illustrates a cross-sectional view of a floating cover 150 within a stock tank 10′, according to an embodiment of the present invention. FIG. 17 illustrates an isometric top view of floating, interlocking insulating blocks 152, according to an embodiment of the present invention. Instead of the stock tank 10′, the stock tank 10 may be used. Additionally, any of the jackets or covers noted above may also be used. Because the blocks 152 interlock with one another, the resulting interlocked cover 150 is not small enough for an animal to fit into its mouth.

Referring to FIGS. 16 and 17, the floating cover 150 includes a plurality of the floating blocks 152. The blocks 152 may be rectangular, hexagonal, octagonal, or the like. The blocks 152 are formed of a material with a low coefficient of thermal conductivity such as closed-cell foam, and are encased in an epoxy or plastic shell to protect the insulating material from exposure. The top surface of each block 152 may be slightly crowned or sloped so that water will run off.

The blocks 152 include shell extensions 154 that extend underneath top surfaces 156 of the blocks 152. The shell extensions 154 prevent adjacent blocks 152 from sliding underneath one another when an animal pushes the block(s) 152 underwater to get a drink.

Thus, an animal may push the block(s) 152 under water in order to gain access to the water. When the animal removes its head from the blocks 152, the buoyancy of the blocks 152 causes them to float on the surface of the water, thereby covering and insulating the water within the stock tank 10′.

Thus, embodiments of the present invention provide systems and methods of insulating conventional stock tanks. Embodiments of the present invention may be used with any stock tank. That is, the embodiments of the present invention do not require a specialized stock tank.

Instead of a specialized stock tank, embodiments of the present invention provide systems and methods of retrofitting conventional stock tanks so that they are insulated.

Embodiments of the present invention provide systems of insulating a stock tank that are formed of materials that are not degraded by the elements, such as rain or snow. Additionally, embodiments of the present invention provide insulating systems that do not include components that may be chewed by animals. Further, embodiments of the present invention provide insulating systems that prevent free movement of air between the insulating material and the walls of the stock tank in order to preclude heat loss by convection.

While various spatial terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for insulating a conventional stock tank configured to retain drinking water for an animal, the system comprising:
at least one insulating member configured to secure to the conventional stock tank, wherein said at least one insulating member is configured to trap air between said at least one insulating member and one or both of a retaining wall of the conventional stock tank or a surface within a water-retaining cavity of the conventional stock tank.

2. The system of claim 1, wherein said at least one insulating member comprises an insulating jacket configured to wrap around the conventional stock tank.

3. The system of claim 2, wherein said insulating jacket includes:
a flexible lining; and
a foam blanket attached to, or enclosed within, said flexible lining.

3. The system of claim 3, wherein said foam blanket is formed of a water-resistant, closed-cell material.

4. The system of claim 3, wherein said foam blanket is formed of open-cell foam.

5. The system of claim 3, wherein said flexible lining is formed of an elastomeric material.

6. The system of claim 3, further comprising at least one draw string secured to said flexible lining.

7. The system of claim 2, wherein said insulating jacket comprises a plurality of vertical air pockets.

8. The system of claim 2, wherein said insulating jacket comprises a plurality of spacer tubes, wherein said spacer tubes are configured to be sandwiched between said insulating jacket and the retaining wall of the conventional stock tank.

9. The system of claim 1, wherein said at least one insulating member comprises a cover suspended above an opening of the conventional stock tank by a rigid frame.

10. The system of claim 9, wherein said cover comprises at least one flap over at least one opening, wherein said flap is configured to be engaged by an animal to allow the animal to gain access to water within the conventional stock tank.

11. The system of claim 10, wherein said at least one flap is spring-biased.

12. The system of claim 10, wherein said at least one flap is secured to said cover through at least one hinge.

13. The system of claim 1, wherein said at least one insulating member comprises a plurality of flexible vertical straps connected to a covering wall, wherein said plurality of flexible vertical straps are configured to be positioned about an opening of the conventional stock tank.

14. The system of claim 1, wherein said at least one insulating member comprises a drinking chute configured to be secured to the conventional stock tank, and a flexible cover that stretches from an upper portion of the conventional stock tank to upper portions of said drinking chute.

15. The system of claim 14, further comprising a float within said drinking chute.

16. The system of claim 1, wherein said at least one insulating member comprises a floating cover including a plurality of floating, interlocking insulating blocks.

17. A system for preventing livestock drinking water from freezing, the system comprising:
a conventional stock tank having a base integrally connected to retaining walls, wherein a water-retaining cavity is defined between said base and said retaining walls; and
at least one insulating member configured to secure to the conventional stock tank, wherein said at least one insulating member is configured to trap air between said at least one insulating member and one or both of said retaining walls of said conventional stock tank or a surface within said water-retaining cavity of the conventional stock tank.

18. The system of claim 17, wherein said at least one insulating member comprises an insulating jacket configured to wrap around said retaining wall of said conventional stock tank.

19. The system of claim 18, wherein said insulating jacket includes:
a flexible lining;
a foam blanket attached to, or enclosed within, said flexible lining; and
upper and lower draw strings secured to upper and lower portions of said flexible lining, respectively.

20. The system of claim 18, wherein said insulating jacket comprises a plurality of vertical air pockets.

21. The system of claim 18, wherein said insulating jacket comprises a plurality of spacer tubes, wherein said spacer tubes are configured to be sandwiched between said insulating jacket and said retaining wall of said conventional stock tank.

22. The system of claim 17, wherein said at least one insulating member comprises a cover suspended above an opening of said conventional stock tank by a rigid frame.

23. The system of claim 22, wherein said cover comprises at least one flap over at least one opening.

24. The system of claim 17, wherein said at least one insulating member comprises a plurality of flexible vertical straps connected to a covering wall, wherein said plurality of flexible vertical straps are configured to be positioned about an opening of said conventional stock tank.

25. The system of claim 17, wherein said at least one insulating member comprises a drinking chute configured to be secured to said conventional stock tank, and a flexible cover that stretches from an upper portion of said conventional stock tank to upper portions of said drinking chute.

26. The system of claim 25, further comprising a float within said drinking chute.

27. The system of claim 17, wherein said insulating member comprises a floating cover including a plurality of floating, interlocking insulating blocks.

28. A system for insulating a conventional stock tank configured to retain drinking water for an animal, the system comprising:
an insulating jacket configured to securely wrap around a retaining wall of the conventional stock tank, wherein said insulating jacket is configured to trap air between said insulating jacket and said retaining wall; and
a flexible cover suspended above an opening of the conventional stock tank by a rigid frame, wherein said flexible cover is configured to trap air between said flexible cover and a surface within a water-retaining cavity of the conventional stock tank.

29. The system of claim 28, wherein said insulating jacket and said flexible cover are integrally formed as a single unit.

30. The system of claim 28, further comprising a floating cover including a plurality of floating, interlocking insulating blocks, wherein said floating cover is configured to float on water within the water-retaining cavity of the conventional stock tank.
